(19) United States
(12) Patent Application Publication
(10) Pub. No.: US 2015/0098228 A1
(43) Pub. Date: Apr. 9, 2015

(54) LENS FOR AN LED-BASED LIGHT

(71) Applicant: iLumisys, Inc., Troy, MI (US)

(72) Inventors: David L. Simon, Grosse Pointe Woods, MI (US); James M. Amrine, JR., Ann Arbor, MI (US)

(21) Appl. No.: 14/208,546

(22) Filed: Mar. 13, 2014

Related U.S. Application Data
(60) Provisional application No. 61/888,742, filed on Oct. 9, 2013.

(51) Int. Cl. F21K 99/00

(52) U.S. Cl. CPC F21K 9/17; F21K 9/50; F21Y 2103/003
USPC 362/311.02; 362/362

(57) ABSTRACT

An LED-based replacement light for a fluorescent light includes a plurality of LEDs and an elongate housing for the LEDs. The housing is defined at least in part by a lens and has a cross sectional profile that partially falls along a cross sectional profile of a fluorescent light that the LED-based light is designed to replace. In addition, at least a portion of the lens extends beyond the cross sectional profile of the fluorescent light. The LED-based light also includes at least one connector arranged at an end of the housing that is configured for engagement with a socket of a fluorescent light fixture.

### CROSS REFERENCE TO RELATED APPLICATIONS

This application claims priority to U.S. Provisional Patent Application No. 61/888,742 filed Oct. 9, 2013, the entire contents of which is incorporated herein by reference.

### TECHNICAL FIELD

The embodiments disclosed herein relate to a light emitting diode (LED)-based light for replacing a fluorescent light in a standard fluorescent light fixture.

### BACKGROUND

Fluorescent lights are widely used in a variety of locations, such as schools and office buildings. Although conventional fluorescent lights have certain advantages over, for example, incandescent lights, they also pose certain disadvantages including, inter alia, disposal problems due to the presence of toxic materials within the light.

LED-based lights designed as one-for-one replacements for fluorescent lights have appeared in recent years.

### SUMMARY

Disclosed herein are embodiments of LED-based lights. In one aspect, an LED-based replacement light for a fluorescent light comprises: a plurality of LEDs; an elongate housing for the LEDs, the housing defined at least in part by a lens and having a cross sectional profile that partially falls along a cross sectional profile of a fluorescent light that the LED-based light is designed to replace, with at least a portion of the lens extending beyond the cross sectional profile of the fluorescent light; and at least one connector arranged at an end of the housing, the connector configured for engagement with a socket of a fluorescent light fixture.

In another aspect, an LED-based replacement light for a fluorescent light comprises: a plurality of LEDs; an elongate housing for the LEDs, the housing at least partially defined by an opaque lower portion and a lens including an inner lens and an outer lens spaced apart from the inner lens, wherein the cross sectional profiles of the lower portion and the inner lens at least partially fall along a cross sectional profile of a fluorescent light that the LED-based light is designed to replace, with at least a portion of the outer lens extending beyond the cross sectional profile of the fluorescent light; and at least one connector arranged at an end of the housing, the connector configured for engagement with a socket of a fluorescent light fixture.

In yet another aspect, an LED-based light comprises a plurality of LEDs; an elongate housing for the LEDs, the housing at least partially defined by a lens including an inner lens and an outer lens spaced from the inner lens, wherein both the inner lens and the outer lens have an at least partially curved cross sectional profile facing in a common direction away from the plurality of LEDs; and at least one connector arranged at an end of the housing, the connector configured for engagement with a socket of a fluorescent light fixture.

These and other aspects will be described in additional detail below.

### BRIEF DESCRIPTION OF THE DRAWINGS

The various features, advantages and other uses of the present apparatus will become more apparent by referring to the following detailed description and drawings in which:

FIG. 1 is a partial perspective view of an example of an LED-based light;

FIG. 2 is a perspective assembly view of the LED-based light showing a housing including a lower portion and a lens, an LED circuit board, a power supply circuit board and a pair of end caps;

FIG. 3 is a cross section of the LED-based light taken at a position similar to the line A-A in FIG. 1 and illustrating an example of the structure of the lens;

FIG. 4 is an example of a polar light distribution curve for the LED-based light, shown with reference to the polar light distribution curve for a typical LED-based light; and

FIGS. 5 and 6 are additional cross sections of the LED-based light taken at positions similar to the line A-A in FIG. 1 and illustrating alternative examples of the structure of the lens.

### DETAILED DESCRIPTION

This disclosure relates to the structure of the lens of an LED-based light. In one example implementation, the lens includes a lens surface configured to transmit light emanating from the LEDs of the LED-based light and provide a relatively greater diffusive capability to the lens as compared to lenses of typical LED-based lights.

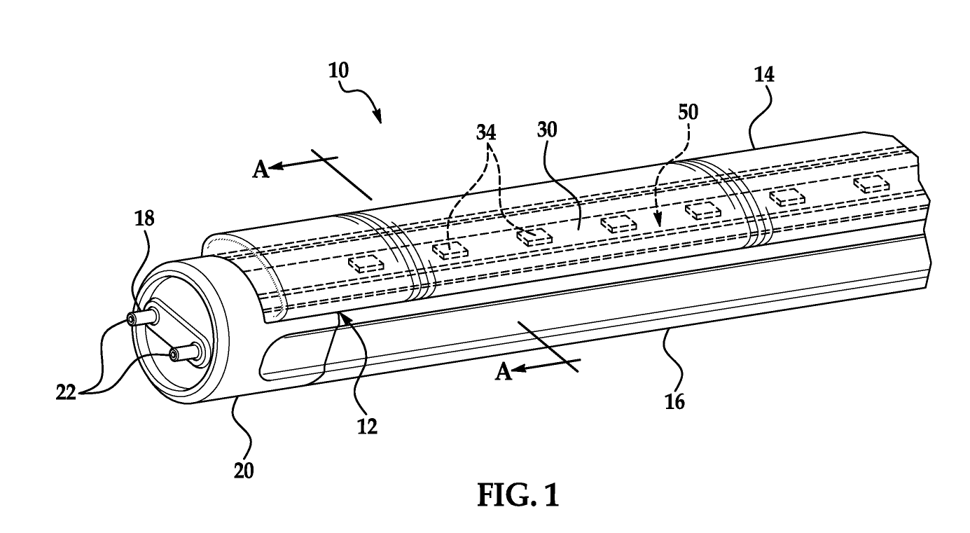

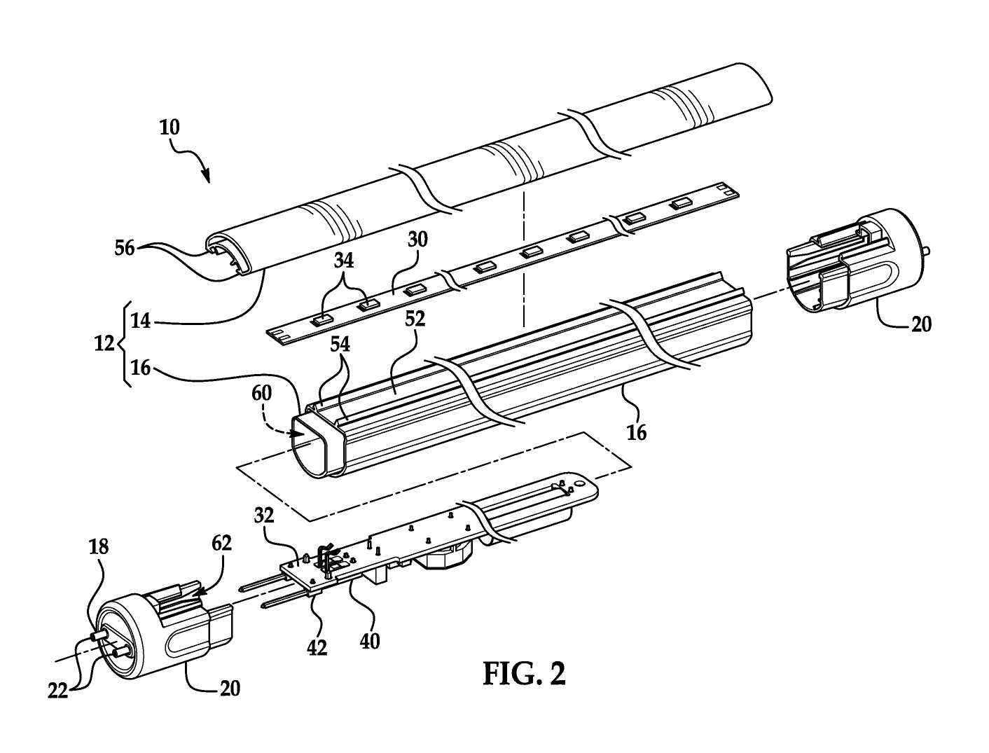

An example of an LED-based light 10 for replacing a conventional light in a standard light fixture is illustrated in FIGS. 1 and 2. The LED-based light 10 includes a housing 12 and has a pair of end caps 20 positioned at the ends of the housing 12. An LED circuit board 30 including the LEDs 34 and a power supply circuit board 32 are arranged within the housing 12.

The housing 12 of the LED-based light 10 can generally define a single package sized for use in a standard fluorescent light fixture. In the illustrated example, the pair of end caps 20 is attached at opposing longitudinal ends of the housing 12 for physically connecting the LED-based light 10 to a light fixture. As shown, each end cap 20 carries an electrical connector 18 configured to physically connect to the light fixture. The electrical connectors 18 can be the sole physical connection between the LED-based light 10 and the light fixture. One example of a light fixture for the LED-based light 10 is a troffer designed to accept conventional fluorescent lights, such as T5, T8 or T12 fluorescent tube lights. These and other light fixtures for the LED-based light 10 can include one or more sockets adapted for physical engagement with the electrical connectors 18. Each of the illustrated electrical connectors 18 is a bi-pin connector including two pins 22. Bi-pin electrical connectors 18 are compatible with many fluorescent light fixtures and sockets, although other types of electrical connectors can be used, such as a single pin connector or a screw type connector.

The light fixture can connect to a power source, and at least one of the electrical connectors 18 can additionally electrically connect the LED-based light 10 to the light fixture to provide power to the LED-based light 10. In this example, each electrical connector 18 can include two pins 22, although two of the total four pins can be “dummy pins” that provide physical but not electrical connection to the light fixture. The light fixture can optionally include a ballast for electrically connecting between the power source and the LED-based light 10.

While the illustrated housing 12 is cylindrical, a housing having a square, triangular, polygonal, or other cross sectional shape can alternatively be used. Similarly, while the illustrated housing 12 is linear, housings having an alternative shape, e.g., a U-shape or a circular shape can alternatively be used. The LED-based light 10 can have any suitable length. For example, the LED-based light 10 may be approximately 48″ long, and the housing 12 can have a 0.625″, 1.0″ or 1.5″ diameter for engagement with a standard fluorescent light fixture.

The housing 12 can be formed by attaching multiple individual parts, not all of which need be light transmitting. For example, illustrated example of the housing 12 is formed in part by attaching a lens 14 at least partially defining the housing 12 to an opaque lower portion 16. The illustrated housing 12 has a generally bipartite configuration defining a first cavity 50 between the lower portion 16 and the lens 14 sized and shaped for housing the LED circuit board 30 and a second cavity 60 defined by the lower portion 16 sized and shaped for housing the power supply circuit board 32.

As shown, the lower portion 16 defines an LED mounting surface 52 for supporting the LED circuit board 30. The LED mounting surface 52 can be substantially flat, so as to support a flat underside of the LED circuit board 30 opposite the LEDs 34. After attachment of the lens 14 to the lower portion 16 during assembly of the LED-based light 10, the LED circuit board 30 is positioned within the first cavity 50 and adjacent the lens 14, such that the LEDs 34 of the LED circuit board 30 are oriented to illuminate the lens 14.

The illustrated lower portion 16 has a tubular construction to define the second cavity 60, although the lower portion 16 could be otherwise configured to define a cavity configured for housing the power supply circuit board 32. The LED-based light 10 can include features for supporting the power supply circuit board 32 within the second cavity 60. For example, as shown, an end cap 20 may include channels 62 configured to slidably receive outboard portions of an end 32a of the power supply circuit board 32. It will be understood that the channels 62 are provided as a non-limiting example and that the power supply circuit board 32 may be otherwise and/or additionally supported within the second cavity 60.

The lower portion 16 may be constructed from a thermally conductive material and configured as a heat sink to enhance dissipation of heat generated by the LEDs 34 during operation to an ambient environment surrounding the LED-based light 10. In the exemplary LED-based light 10, an LED mounting surface 52 of the lower portion 16 is thermally coupled to the LEDs 34 through the LED circuit board 30, and the remainder of the lower portion 16 defines a heat transfer path from the LED mounting surface 52 to the ambient environment.

The lower portion 16 and the lens 14 may each include complementary structures permitting for attachment of the lens 14 to the lower portion 16 to define the first cavity 50. For example, as shown, the lower portion 16 may include a pair of hooked projections 54 for retaining a corresponding pair of projections 56 of the lens 14. The projections 56 of the lens 14 can be slidably engaged with the hooked projections 54 of the lower portion 16, or can be snap fit to the hooked projections 54. The hooked projections 54 can be formed integrally with the lower portion 16 by, for example, extruding the lower portion 16 to include the hooked projections 54. Similarly, the projections 56 can be formed integrally with the lens 14 by, for example, extruding the lens 14 to include the projections 56. The hooked projections 54 and projections 56 can extend the longitudinal lengths of the lower portion 16 and the lens 14, respectively, although a number of discrete hooked projections 54 and/or projections 56 could be used to couple the lens 14 to the lower portion 16. Alternatively, the lower portion 16 could be otherwise configured for attachment with the lens 14. For example, the lens 14 could be clipped, adhered, snap- or friction-fit, screwed or otherwise attached to the lower portion 16.

Alternatively to the illustrated housing 12, the housing 12 can include a light transmitting tube at least partially defined by the lens 14. The lens 14 can be made from polycarbonate, acrylic, glass or other light transmitting material (i.e., the lens 14 can be transparent or translucent). The term “lens” as used herein means a light transmitting structure, and not necessarily a structure for concentrating or diverging light.

Although light fixtures for the LED-based light 10 may include structures and surfaces configured to distribute the light produced by fluorescent lights, these light fixture may not be equipped to effectively distribute the relatively more directional light produced by the LED-based light 10 across an exit plane of the fixture. In these light fixtures, the spacing between multiple LED-based lights 10 can create “hot spots” at locations corresponding to the positions of the LED-based lights 10 on production of light by the LEDs 34. In addition, because the LED-based light 10 is generally a more efficient source of light compared to a fluorescent light, it is contemplated that one or more of the total lights in a light fixture may be eliminated during a retrofit replacement of fluorescent lights with the LED-based lights 10. This in turn may accentuate the existence and appearance of hot spots.

According to one example implementation of the LED-based light 10, the lens 14 is configured with features for modifying and diffusively transmitting the light emanating from the LEDs 34 of the LED-based light 10. Although the description follows with general reference to the spatial aspects of the light transmitted from the lens 14, it will be understood that the lens 14 could be additionally configured to modify, for instance, the spectral aspects of the emanated light.

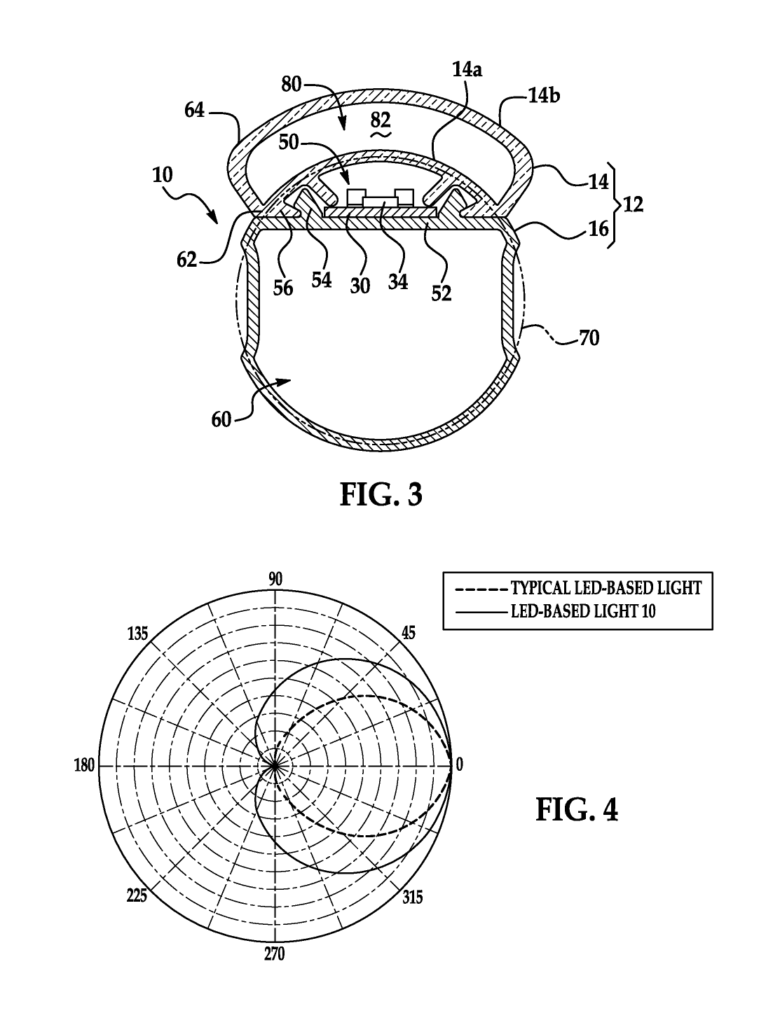

An example of the structure of the lens 14 is discussed in greater detail with additional reference to FIG. 3. The illustrated lens 14 has a first, inner lens 14a and a second, outer lens 14b. In the illustrated LED-based light 10, the inner lens 14a generally spans the LED mounting surface 52 of the lower portion 16 of the housing 12 to enclose the LEDs 34 in conjunction with the end caps 20.

The outer lens 14b is arranged over, and generally spans, the inner lens 14a. As shown, both the outer lens 14b and the inner lens 14a are joined at common, opposing longitudinally extending edges 62 forming respective bases for the pair of hooked projections 54. With both the inner lens 14a and the outer lens 14b having commonly facing curved profiles between the opposing longitudinally extending edges 62, the inner lens 14a and the outer lens 14b together have a hollow, generally crescent shaped cross section.

The inner lens 14a and the outer lens 14b of the lens 14 can be formed integrally using an extrusion process, for example. Alternatively, the lower portion 16 of the housing 12, the inner lens 14a and/or the outer lens 14b can include features permitting for attachment of the outer lens 14b to the LED-based light 10 in a spaced relationship to the lower lens surface 14a.

The line 70 overlaying the cross section of the LED-based light 10 in FIG. 3 is indicative of the cross sectional profile of a fluorescent light that the LED-based light 10 is designed to replace. In accordance with typical fluorescent lights, the line 70 is generally circular and may have a 0.625″, 1.0″ or 1.5″ diameter, for example. As shown, the lower portion 16 of the housing 12 and the inner lens 14a each have cross sectional profiles with radially outer portions that substantially fall along the line 70.

In the illustrated LED-based light 10, substantially the entire outer lens 14b is spaced radially outward from the inner lens 14a, further from the LEDs 34 than the inner lens 14a. It follows that, although a portion of the outer lens 14b, such as the opposing longitudinally extending edges 62, may generally fall on or near the line 70 indicating the cross sectional profile of a fluorescent light that the LED-based light 10 is designed to replace, substantially all of the radially outer portion of the cross sectional profile of the outer lens 14b falls outside of the line 70. This arrangement may, among other things, provide an advantage with respect to the diffusion of the light emanating from the LEDs 34.

In general, in diffusing the light emanating from a light source with an angular spread, such as the LEDs 34, a lens can effectively utilize the extent to which the light emanating from the LEDs 34 is already spread over space. Thus, for LEDs 34 with a given spread, the effectiveness of a lens in diffusing the light emanating from the LEDs 34 of the LED-based light 10 is a product of, among other things, the proximity of the lens to the LEDs 34. The radially outward spacing of the outer lens 14b in the illustrated lens 14 therefore allows for greater diffusion of the light emanating from the LEDs 34, as compared, for example, to the inner lens 14a in the illustrated LED-based light 10 or lenses in other LED-based lights that similarly fall along the cross sectional profile of a fluorescent light.

The outer lens 14b can be also be sized and shaped such that, in addition to diffusing the light passed by the inner lens 14a, the outer lens 14b transmits the light emanating from the LEDs 34 with a greater angular distribution than achieved with a similar LED-based light 10 having a lens 14 without the outer lens 14b.

For the illustrated LED-based light 10, the inner lens 14a is configured to pass the light emanated from the LEDs 34 into a space 80 defined between the inner lens 14a and the outer lens 14b, and the outer lens 14b is configured to diffusively transmit the light passed by the inner lens 14a to into the environment surrounding the LED-based light 10. On production of light by the LEDs 34 of the LED-based light 10, reflection between the inner lens 14a and the outer lens 14b causes the space 80 to act as a mixing chamber for the light emanated from the LEDs 34 prior to transmission from the outer lens 14b. With the space 80 acts as a mixing chamber for the light emanated from the LEDs 34 in this manner, the light is transmitted from all or substantially all of the outer lens 14b, such that the outer lens 14b as a whole acts as the effective source of light for the LED-based light 10 for purposes of light distribution.

As explained above, the lower portion 16 of the housing 12 and the lower lens surface 14a each have cross sectional profiles with radially outer portions that substantially fall along the line 70 indicating the cross sectional profile of a fluorescent light. Moreover, for the illustrated LED-based light 10, these radial outer portions together substantially fall along the full circumference of the line 70. In this arrangement, the radial outer portion of the inner lens 14a generally falls along a minor arc of the line 70, with the radial outer portion of the lower portion 16 of the housing 12 falling along a major arc of the line 70.

The LEDs 34 generally face the lens 14, with the lens 14, in cross section, being centered normal to the LEDs 34. In operation, the LEDs 34 of the LED-based light 10 may be configured to emanate light generally in line with the LEDs 34 with a radial distribution centered normal to the LEDs 34. The light emanating from the LEDs 34 may, for instance, be distributed to occupy an approximately 100° to 120° spread from normal to the LEDs 34.

Absent the outer lens 14b, in which case the inner lens 14a as a whole would act as the effective source of light for the LED-based light 10, the LED-based light 10 is somewhat limited in its ability to distribute the light emanating from the LEDs 34 in a direction opposite the lens 14. Specifically, with the radial outer portion of the inner lens 14a generally falling along a minor arc of the line 70, much if not all of the light transmitted from the inner lens 14a at or proximate to the junction between the lens 14 and the lower portion 16 of the housing 12 (e.g., for the illustrated LED-based light 10, at the opposing longitudinally extending edges 62 of the lens 14) is blocked by the non-light transmitting lower portion 16 from being distributed in a direction opposite the lens 14. An example of a resulting light distribution for a typical LED-based light with this general configuration is shown in FIG. 4. As shown, for the typical LED-based light, little if any of the light emanating from the LEDs 34 is distributed in a direction opposite the lens 14. That is, the light emanating from the LEDs 34 is generally distributed with an angular distribution of 180° or less from normal to the LEDs 34.

In the illustrated example of the LED-based light 10 including the lens 14 having the outer lens 14b, with the outer lens 14b as a whole acting as the effective source of light for the LED-based light 10 for purposes of light distribution, the light emanating from the LEDs 34 may be distributed in a direction opposite the lens 14.

In particular, at least a portion of the outer lens 14b in the LED-based light 10 projects beyond the junction between the lens 14 and the lower portion 16 of the housing 12 (e.g., for the illustrated LED-based light 10, at the opposing longitudinally extending edges 62 of the lens 14). Thus, at least some of the light transmitted from these portions of the outer lens 14b is not blocked by the non-light transmitting lower portion 16 from being distributed in a direction opposite the lens 14. In the illustrated example of the LED-based light 10, for example, the outer lens 14b includes bulges 64 at the opposing longitudinally extending edges 62, which project beyond the lower portion 16 of the housing 12. Although the bulges 64 are given as one non-limiting example, it will be understood that in other examples of the LED-based light 10 the outer lens 14b may include other structures that project beyond the lower portion 16 of the housing 12.

An example of a resulting light distribution for the illustrated example of the LED-based light 10 with the illustrated configuration is shown in FIG. 4. As shown, for the LED-based light 10, at least a portion of the light emanating from the LEDs 34 is distributed in a direction opposite the lens 14. Therefore, as shown, the light emanating from the LEDs 34 is generally distributed with an angular distribution of 180° or more from normal to the LEDs 34.

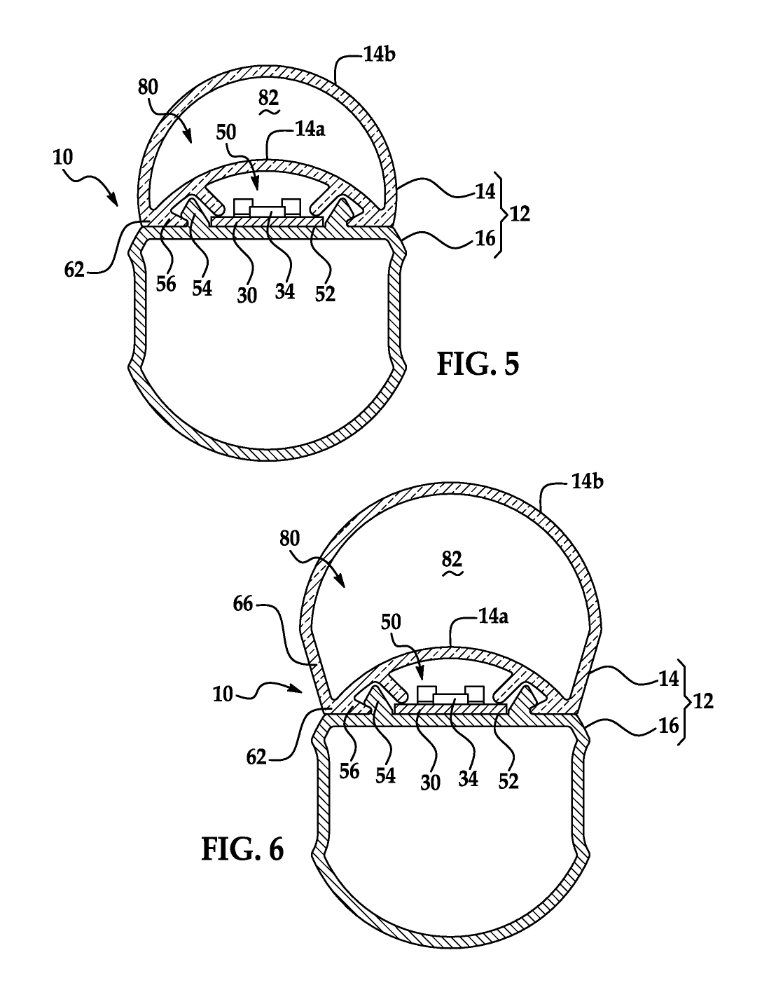

Alternative examples of the structure of the lens 14 are shown in FIGS. 5 and 6. In these examples, the configuration of the inner lens 14a is substantially as described above. The outer lens 14b in these examples is also similarly arranged over, and generally spans, the inner lens 14a, and as in the example of FIG. 3, both the outer lens 14b and the inner lens 14a are joined at common, opposing longitudinally extending edges 62 forming respective bases for the pair of hooked projections 54. In addition, in these examples, both the inner lens 14a and the outer lens 14b have commonly facing, at least partially curved profiles between the opposing longitudinally extending edges 62, such that the inner lens 14a and the outer lens 14b together have a hollow, generally crescent shaped cross section.

In FIG. 5, the outer lens 14b is generally semi-circular. In addition, the outer lens 14b is even further spaced from the inner lens 14a as compared to the example of FIG. 3, allowing for greater diffusion of the light emanating from the LEDs 34.

In FIG. 6, the outer lens 14b is similarly even further spaced from the inner lens 14a as compared to the example of FIG. 3, allowing for greater diffusion of the light emanating from the LEDs 34. In addition, at least a portion of the outer lens 14b in the LED-based light 10 projects beyond the junction between the lens 14 and the lower portion 16 of the housing 12 (e.g., for the illustrated LED-based light 10, at the opposing longitudinally extending edges 62 of the lens 14). In this example of the LED-based light 10, the outer lens 14b includes opposing upright side walls 66 that are angled outward from the opposing longitudinally extending edges 62 to project beyond the lower portion 16 of the housing 12, such that the light emanating from the LEDs 34 is generally distributed with an angular distribution of 180° or more from normal to the LEDs 34.

The lens 14 can be manufactured to include light diffusing structures, such as ridges, dots, bumps, dimples or other uneven surfaces formed on an interior or exterior of the outer lens 14b. The light diffusing structures can be formed integrally with the outer lens 14b, for example, by molding or extruding, or the structures can be formed in a separate manufacturing step such as surface roughening. Alternatively, the material from which the outer lens 14b is formed can include light refracting particles. For example, the outer lens 14b can be made from a composite, such as polycarbonate, with particles of a light refracting material interspersed in the polycarbonate.

The outer lens 14b may be configured to transmit the light emanating from the LEDs 34 uniformly. Alternatively, in some implementations, outer lens 14b may have one or more portions that include an opaque and/or reflective material to block those portions from transmitting the light emanating from the LEDs 34. For example, a central reflection strip (e.g., one made of a reflective material such as aluminized mylar) may be applied to the length of an interior central portion of the outer lens 14b to prevent light from being emitted directly downwards from the outer lens 14b, thereby making the LED-based light 10 an indirect light source. In other examples, one or more portions of the outer lens 14b can be provided with a different diffusing texture, an optical control film such as multi-layer dielectric reflector, or other features that change the localized appearance of the light transmitted from the outer lens 14b at those portions. Similarly, one or more variable internal reflectors may be included on the outer lens 14b or in the space 80 between the inner lens 14a and the outer lens 14b to transmit a variety of different patterns of light from the outer lens 14b. In addition to or as an alternative to the foregoing features, the space 80 between the inner 14a and the outer lens 14b can be filled with silicone or other light transmitting material to allow for further manipulation of the transmission of light from the outer lens 14b. The light transmitting material may, for example, be further configured with thermal properties to aid in heat transfer from the lens 14. In these or other examples of the lens 14, the space 80 can be closed off using plugs 82. The plugs 82 could be formed integrally with the lens 14, for example, or could be formed separately from the lens 14 and applied in a separate manufacturing step.

The lens 14 can optionally be manufactured to include similar light diffusing structures on an interior or exterior of the inner lens 14a. However, in one example configuration of the lens 14, the inner lens 14a can be substantially transparent and configured simply to pass the light emanated from the LEDs 34 into the space 80 formed between the inner lens 14a and the outer lens 14b. In this example configuration, any efficiency losses that would arise by diffusing the light emanated from the LEDs 34 as it passes through the inner lens 14a are avoided. It will be understood that in this configuration, for the illustrated LED-based light 10, the inner lens 14a may still serve the function of enclosing the LEDs 34 in accordance with regulatory, design or other criteria.

The LED-based light 10 can include other features for distributing light produced by the LEDs 34. For example, the lens 14 can be manufactured with structures at the inner lens 14a and/or the outer lens 14b to collimate light produced by the LEDs 34. The light collimating structures can be formed integrally with the lens 14, for example, or can be formed in a separate manufacturing step. In addition to or as an alternative to manufacturing the lens 14 to include light collimating structures, a light collimating film can be applied to the inner lens 14a and/or the outer lens 14b.

In yet other embodiments, the LEDs 34 can be over molded or otherwise encapsulated with light transmitting material configured to distribute light produced by the LEDs 34. For example, the light transmitting material can be configured to diffuse, refract, collimate and/or otherwise distribute the light produced by the LEDs 34. The over molded LEDs 34 can be used alone to achieve a desired light distribution for the LED-based light 10, or can be implemented in combination with the lens 14 and/or films described above.

The above described or other light distributing features can be implemented uniformly or non-uniformly along a length and/or circumference of the LED-based light 10. These features are provided as non-limiting examples, and in other embodiments, the LED-based light 10 may not include any light distributing features.

The LED circuit board 30 can include at least one LED 34, a plurality of series-connected or parallel-connected LEDs 34, an array of LEDs 34 or any other arrangement of LEDs 34. Each of the illustrated LEDs 34 can include a single diode or multiple diodes, such as a package of diodes producing light that appears to an ordinary observer as coming from a single source. The LEDs 34 can be surface-mount devices of a type available from Nichia, although other types of LEDs can alternatively be used. For example, the LED-based light 10 can include high-brightness semiconductor LEDs, organic light emitting diodes (OLEDs), semiconductor dies that produce light in response to current, light emitting polymers, electro-luminescent strips (EL) or the like. The LEDs 34 can emit white light. However, LEDs that emit blue light, ultra-violet light or other wavelengths of light can be used in place of or in combination with white light emitting LEDs 34.

The orientation, number and spacing of the LEDs 34 can be a function of a length of the LED-based light 10, a desired lumen output of the LED-based light 10, the wattage of the LEDs 34, a desired light distribution for the LED-based light 10 and/or the viewing angle of the LEDs 34.

The LEDs 34 can be fixedly or variably oriented in the LED-based light 10 for facing or partially facing an environment to be illuminated when the LED-based light 10 is installed in a light fixture. Alternatively, the LEDs 34 can be oriented to partially or fully face away from the environment to be illuminated. In this alternative example, the LED-based light 10 and/or a light fixture for the LED-based light 10 may include features for reflecting or otherwise redirecting the light produced by the LEDs into the environment to be illuminated.

For a 48″ LED-based light 10, the number of LEDs 34 may vary from about thirty to three hundred such that the LED-based light 10 outputs between 1,500 and 3,000 lumens. However, a different number of LEDs 34 can alternatively be used, and the LED-based light 10 can output any other amount of lumens.

The LEDs 34 can be arranged in a single longitudinally extending row along a central portion of the LED circuit board 30 as shown, or can be arranged in a plurality of rows or arranged in groups. The LEDs 34 can be spaced along the LED circuit board 30 and arranged on the LED circuit board 30 to substantially fill a space along a length of the lens 14 between end caps 20 positioned at opposing longitudinal ends of the housing 12. The spacing of the LEDs 34 can be determined based on, for example, the light distribution of each LED 34 and the number of LEDs 34. The spacing of the LEDs 34 can be chosen so that light output by the LEDs 34 is uniform or non-uniform along a length of the lens 14. In one implementation, one or more additional LEDs 34 can be located at one or both ends of the LED-based light 10 so that an intensity of light output at the lens 14 is relatively greater at the one or more ends of the LED-based light 10. Alternatively, or in addition to spacing the LEDs 34 as described above, the LEDs 34 nearer one or both ends of the LED-based light 10 can be configured to output relatively more light than the other LEDs 34. For instance, LEDs 34 nearer one or both ends of the LED-based light 10 can have a higher light output capacity and/or can be provided with more power during operation.

The power supply circuit board 32 is positioned within the housing 12 adjacent the electrical connector 18 and has power supply circuitry configured to condition an input power received from, for example, the light fixture through the electrical connector 18, to a power usable by and suitable for the LEDs 34. In some implementations, the power supply circuit board 32 can include one or more of an inrush protection circuit, a surge suppressor circuit, a noise filter circuit, a rectifier circuit, a main filter circuit, a current regulator circuit and a shunt voltage regulator circuit. The power supply circuit board 32 can be suitably designed to receive a wide range of currents and/or voltages from a power source and convert them to a power usable by the LEDs 34.

The LED-based light 10 may require a number of electrical connections to convey power between the various illustrated spatially distributed electrical assemblies included in the LED-based light 10, such as the LED circuit board 30, the power supply circuit board 32 and the electrical connector 18. These connections can be made using a circuit connector header 40 and a pin connector header 42, as shown in FIG. 3. In particular, when the LED-based light 10 is assembled, the circuit connector header 40 may be arranged to electrically couple the LED circuit board 30 to the power supply circuit board 32, and the pin connector header 42 may be arranged to electrically couple the power supply circuit board 32 to the pins 22 of an end cap 20.

As shown, the LED circuit board 30 and the power supply circuit board 32 are vertically opposed and spaced with respect to one another within the housing 12. The LED circuit board 30 and the power supply circuit board 32 can extend a length or a partial length of the housing 12, and the LED circuit board 30 can have a length different from a length of the power supply circuit board 32. For example, the LED circuit board 30 can generally extend a substantial length of the housing 12, and the power supply circuit board 32 can extend a partial length of the housing. However, it will be understood that the LED circuit board 30 and/or the power supply circuit board 32 could be alternatively arranged within the housing 12, and that the LED circuit board 30 and the power supply circuit board 32 could be alternatively spaced and/or sized with respect to one another.

The LED circuit board 30 and the power supply circuit board 32 are illustrated as elongate printed circuit boards. Multiple circuit board sections can be joined by bridge connectors to create the LED circuit board 30 and/or power supply circuit board 32. Also, other types of circuit boards may be used, such as a metal core circuit board. Further, the components of the LED circuit board 30 and the power supply circuit board 32 could be in a single circuit board or more than two circuit boards.

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An LED-based replacement light for a fluorescent light, comprising:
a plurality of LEDs;
an elongate housing for the LEDs, the housing defined at least in part by a lens and having a cross sectional profile that partially falls along a cross sectional profile of a fluorescent light that the LED-based light is designed to replace, with at least a portion of the lens extending beyond the cross sectional profile of the fluorescent light; and
at least one connector arranged at an end of the housing, the connector configured for engagement with a socket of a fluorescent light fixture.

2. The LED-based light of claim 1, wherein the lens includes an inner lens and an outer lens spaced apart from the inner lens, with at least a portion of the outer lens extending beyond the cross sectional profile of the fluorescent light.

3. The LED-based light of claim 2, wherein the inner lens at least partially encloses the plurality of LEDs and is configured to pass light that is emanated from the plurality of LEDs, and the outer lens is configured to diffusively transmit the light passed by the inner lens.

4. The LED-based light of claim 2, wherein at least a portion of the inner lens falls along the cross sectional profile of the fluorescent light.

5. The LED-based light of claim 2, wherein both the inner lens and the outer lens have an at least partially curved cross sectional profile, with the inner lens and the outer lens sharing opposing longitudinally extending edges.

6. The LED-based light of claim 2, wherein a space between the inner lens and the outer lens is at least partially filled with a light transmitting material.

7. The LED-based light of claim 1, wherein the housing is further defined at least in part by an opaque lower portion, with the lens being attached to the lower portion such that an elongate junction is formed between the lens and the lower portion at the cross sectional profile of the housing, and wherein the portion of the lens extending beyond the cross sectional profile of the fluorescent light at least partially projects beyond the junction.

8. The LED-based light of claim 7, wherein the portion of the lens that at least partially projects beyond the junction is a bulge.

9. The LED-based light of claim 7, wherein the portion of the lens that at least partially projects beyond the junction is an angled side wall.

10. The LED-based light of claim 7, wherein at least a portion of the lower portion falls along the cross sectional profile of the fluorescent light.

11. The LED-based light of claim 1, wherein the plurality of LEDs are configured to emanate light at a first angle less than 180 degrees, and the lens is configured to transmit light that is emanated from the LEDs at a second angle greater than 180 degrees.

12. An LED-based replacement light for a fluorescent light, comprising:
a plurality of LEDs;
an elongate housing for the LEDs, the housing at least partially defined by an opaque lower portion and a lens including an inner lens and an outer lens spaced apart from the inner lens, wherein the cross sectional profiles of the lower portion and the inner lens at least partially fall along a cross sectional profile of a fluorescent light that the LED-based light is designed to replace, with at least a portion of the outer lens extending beyond the cross sectional profile of the fluorescent light; and
at least one connector arranged at an end of the housing, the connector configured for engagement with a socket of a fluorescent light fixture.

13. The LED-based light of claim 12, wherein radially outer portions of the cross sectional profiles of the lower portion and the inner lens substantially fall along the cross sectional profile of the fluorescent light.

14. The LED-based light of claim 12, wherein a radially outer portion of a cross sectional profile of the inner lens substantially falls along only a minor arc of the cross sectional profile of the fluorescent light, both the inner lens and the outer lens share opposing longitudinally extending edges located at opposing elongate junctions formed between the lens and the lower portion, and the outer lens at least partially projects beyond each of the junctions.

15. The LED-based light of claim 14, wherein a portion of the lens that at least partially projects beyond a junction is a bulge.

16. The LED-based light of claim 14, wherein a portion of the lens that at least partially projects beyond a junction is an angled side wall.

17. The LED-based light of claim 14, wherein both the inner lens and the outer lens have an at least partially curved cross sectional profile.

18. The LED-based light of claim 12, wherein the inner lens at least partially encloses the plurality of LEDs and is configured to substantially pass light that is emanated from the plurality of LEDs, and the outer lens is configured to diffusively transmit the light passed by the inner lens at an angle greater than 180 degrees.

19. An LED-based light, comprising:
a plurality of LEDs;
an elongate housing for the LEDs, the housing at least partially defined by a lens including an inner lens and an outer lens spaced from the inner lens, wherein both the inner lens and the outer lens have an at least partially curved cross sectional profile facing in a common direction away from the plurality of LEDs; and
at least one connector arranged at an end of the housing, the connector configured for engagement with a socket of a fluorescent light fixture.

20. The LED-based light of claim 19, wherein the outer lens overlays the inner lens and is attached to the inner lens at opposed longitudinally extending edges, with the inner lens and the outer lens together forming a closed and generally crescent shaped cross sectional profile.
